(19) United States
(12) Patent Application Publication
(10) Pub. No.: US 2026/0239346 A1
(43) Pub. Date: Aug. 13, 2026

(54) PUCCH CONFIGURATION WITH LIGHT ADAPTATION

(71) Applicant: QUALCOMM Incorporated, San Diego, CA (US)

(72) Inventors: Diana MAAMARI, San Diego, CA (US); Gabi SARKIS, San Diego, CA (US); Mostafa KHOSHNEVISAN, San Diego, CA (US)

(21) Appl. No.: 19/051,065

(22) Filed: Feb. 11, 2025

(51) Int. Cl. H04W 72/21; H04L 1/1812; H04W 72/0457; H04W 72/51

(52) U.S. Cl. CPC H04W 72/21; H04L 1/1812; H04W 72/0457; H04W 72/51

(57) ABSTRACT

This disclosure provides systems, methods and apparatuses for light adaptation of sub-bandwidth parts (subBWPs) including associated configuration of physical uplink control channel (PUCCH) resources. A user equipment (UE) obtains a configuration of a plurality of subBWPs within a single bandwidth part, the subBWPs having different bandwidths. The UE obtains a configuration of a plurality of PUCCH resource sets, the configuration having an indication of whether each PUCCH resource set or each PUCCH resource in the plurality of PUCCH resource sets is valid for one or more of the subBWPs. The UE obtains an indication that one of the subBWPs is an active subBWP. The UE outputs a PUCCH based on the active subBWP and based on whether the PUCCH resource set or the PUCCH resource is valid for the active subBWP.

### TECHNICAL FIELD

The present disclosure relates to wireless communications including physical uplink control channel (PUCCH) configuration with light adaptation

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

In some aspects, the techniques described herein relate to an apparatus for wireless communication, including: one or more memories, individually or in combination, having instructions; and one or more processors, individually or in combination, configured to execute the instructions and cause the apparatus to: obtain a configuration of a plurality of sub-bandwidth parts (subBWPs) within a single bandwidth part, the subBWPs having different bandwidths; obtain a configuration of a plurality of physical uplink control channel (PUCCH) resource sets, the configuration having an indication of whether each PUCCH resource set or each PUCCH resource in the plurality of PUCCH resource sets is valid for one or more of the subBWPs; obtain an indication that one of the subBWPs is an active subBWP; and output a PUCCH based on the active subBWP and based on whether the PUCCH resource set or the PUCCH resource is valid for the active subBWP.

In some aspects, the techniques described herein relate to an apparatus for wireless communication, including: one or more memories, individually or in combination, having instructions; and one or more processors, individually or in combination, configured to execute the instructions and cause the apparatus to: output a configuration of a plurality of sub-bandwidth parts (subBWPs) within a single bandwidth part, the subBWPs having different bandwidths; output a configuration of a plurality of physical uplink control channel (PUCCH) resource sets, the configuration having an indication of whether each PUCCH resource set or a PUCCH resource in the plurality of PUCCH resource sets is valid for one or more of the subBWPs; output an indication that one of the subBWPs is an active subBWP; and obtain a PUCCH based on the active subBWP and based on whether the PUCCH resource set or the PUCCH resource is valid for the active subBWP.

In some aspects, the techniques described herein relate to a method of wireless communication, including: obtaining a configuration of a plurality of sub-bandwidth parts (subBWPs) within a single bandwidth part, the subBWPs having different bandwidths; obtaining a configuration of a plurality of physical uplink control channel (PUCCH) resource sets, the configuration having an indication of whether each PUCCH resource set or each PUCCH resource in the plurality of PUCCH resource sets is valid for one or more of the subBWPs; obtaining an indication that one of the subBWPs is an active subBWP; and outputting a PUCCH based on the active subBWP and based on whether the PUCCH resource set or the PUCCH resource is valid for the active subBWP.

In some aspects, the techniques described herein relate to a method of wireless communication, including: outputting a configuration of a plurality of sub-bandwidth parts (subBWPs) within a single bandwidth part, the subBWPs having different bandwidths; outputting a configuration of a plurality of physical uplink control channel (PUCCH) resource sets, the configuration having an indication of whether each PUCCH resource set or a PUCCH resource in the plurality of PUCCH resource sets is valid for one or more of the subBWPs; outputting an indication that one of the subBWPs is an active subBWP; and obtaining a PUCCH based on the active subBWP and based on whether the PUCCH resource set or the PUCCH resource is valid for the active subBWP.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system including an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 is a diagram illustrating an example disaggregated base station architecture.

FIG. 5 is a diagram illustrating switching between sub-bandwidth parts (subBWPs).

FIG. 6 is a diagram of physical uplink control channel (PUCCH) configuration associated with subBWPs.

FIG. 7 is a diagram PUCCH configuration with frequency hopping associated with subBWPs.

FIG. 8 is a message diagram illustrating various messages for PUCCH configuration with light adaptation.

FIG. 9 is a conceptual flow diagram illustrating the data flow between different means/components in an example network entity including a including a light adaptation component.

FIG. 10 is a conceptual data flow diagram illustrating the data flow between different means/components in an example UE including a including a light adaptation component.

FIG. 11 is a flowchart of an example method for a wireless node such as a UE to transmit a PUCCH based on an active subBWP using light adaptation.

FIG. 12 is a flowchart of an example method for a wireless node such as a network entity to receive a PUCCH based on an active subBWP using light adaptation.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, 6G or further implementations thereof, technology.

In wireless communications, a wireless node may be configured to communicate over a frequency bandwidth. Some wireless communications systems allow changes to the bandwidth for efficiency and energy savings. For example, 5G new radio (NR) introduced the concept of a bandwidth part (BWP) to enable fast and low-overhead adaptation of radio parameters. Radio resource control (RRC) parameters are organized in a BWP container. A BWP change can be signaled via RRC signaling or downlink control information (DCI) signaling, or via expiration of a BWP inactivity timer. One original motivation for BWP switching was to simplify switching parameters that impact user equipment (UE) power consumption.

As standardized in 5G NR, BWP switching has several issues that reduce effectiveness. For example, an out of synchronization (OOS) issue can occur when the switching signaling is missed. For example, failure to decode a DCI, a DCI where the network does not receive an acknowledgment, a physical uplink shared channel (PUSCH) discontinuous transmission (DTX), or proprietary conflict windows can result in a scenario where the network switches to a new BWP while the UE remains in an old BWP, or the UE switches to a new BWP while the network remains in the old BWP. An OOS issue is particularly problematic when BWPs do not overlap in the frequency domain or there is a rank change because the DCI may become undecodable, so the UE misses additional signaling to correct the OOS issue. Although there is also an OOS issue for time domain BWP differences, there is typically some overlap such that recovery signaling can be received. Additionally, BWP switching may change a large number of RRC parameters including ones that affect the DCI or the control resource set (CORESET) on which DCI is received. A change in BWP may result in a change in DCI size and field configuration, which may also render a DCI undecodable in the event of an OOS issue.

Another issue with BWP switching is the BWP switching delay. Due to the number and types of parameters that are configured in a BWP, significant time is allowed for the UE to switch BWPs. For instance, the BWP switching delay may be multiple slots or approximately 1-3 ms depending on the specific scenario.

One proposal for improving frequency domain adaptation is referred to as light adaptation. Light adaptation may provide limited changes in radio parameters such that the switching may be performed quickly while reducing the impact of OOS issues. A light adaptation framework may still rely on the concept and configuration of BWPs. Light adaptation may further define a smaller frequency domain unit, which may be referred to as a subBWP, a subband, or a resource block (RB) set, for example. Control information (e.g., a DCI) may be used to signal the UE to switch between subBWPs. Light adaptation may be an additional option to support power savings, while BWP switching is still available for other changes. Light adaptation may allow changes to radio parameters that do not affect the DCI size and fields. For instance, light adaptation may change bandwidth, number of active antennas and maximum rank, timeline (including minimum scheduling offset), and search space periodicity (but not CORESET). Accordingly, the DCI remains unchanged during light adaptation, which ensures that the UE can decode the DCI, even when OOS. Light adaptation also reduces that amount of reconfiguration needed at the UE.

Proposals for light adaptation have focused on the downlink changes. The change in bandwidth for light adaptation may also affect uplink signaling such as a physical uplink control channel (PUCCH). The PUCCH may also be affected by OOS issues and play an important role in OOS recovery. Accordingly, there is a need for a PUCCH design for light adaptation.

In an aspect, the present disclosure provides for a PUCCH configuration that automatically adapts during light adaptation using a plurality of subBWPs. The PUCCH configuration indicates whether each PUCCH resource set or each PUCCH resource is valid for one or more of the subBWPs. When the UE receives a DCI that indicates an active subBWP, the UE may determine a PUCCH resource based on whether the PUCCH resource set or the PUCCH resource is valid for the active subBWP. The UE may transmit the PUCCH on the PUCCH resource, for example, to carry an acknowledgment of a transmission scheduled by the DCI. In some implementations, the UE may detect an OOS issue, for example, when the UE receives a DCI that indicates a transmission outside of the active subBWP. The UE may transmit a PUCCH that indicates the OOS issue either before or after switching subBWPs.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

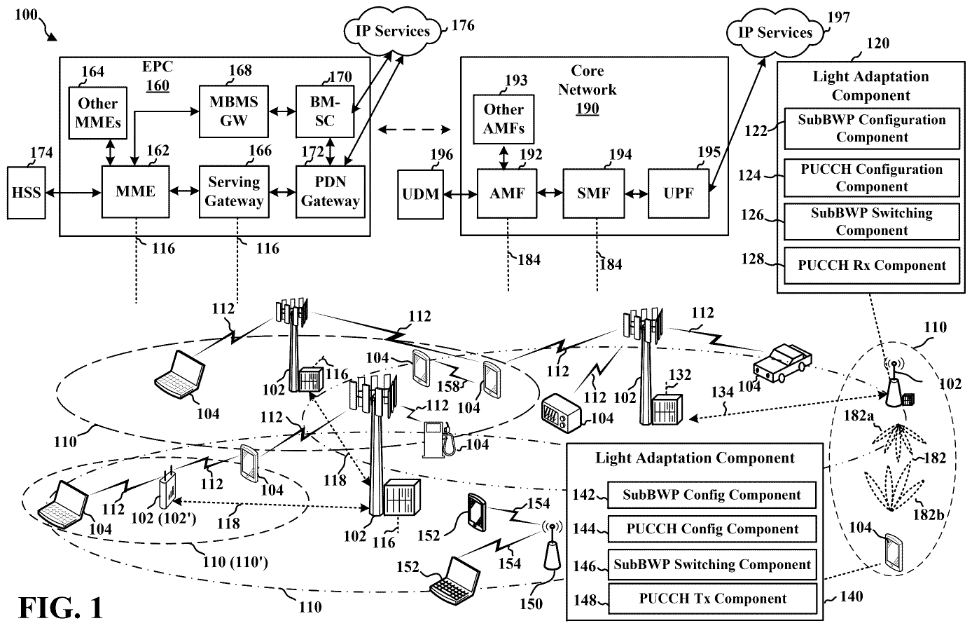

FIG. 1 is a diagram illustrating an example of a wireless communications system and an access network 100. The wireless communications system (also referred to as a wireless wide area network (WWAN)) includes wireless nodes such as base stations 102 and UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as one or more central units (CUs) 188, one or more distributed units (DUs) 186, or a radio unit (RU) 180. Such architectures may be configured to utilize a protocol stack that is logically split between one or more units (such as one or more CUs and one or more DUs). In some aspects, the CUs 188 may be implemented within an edge RAN node, and in some aspects, one or more DUs 186 may be co-located with a CU 188, or may be geographically distributed throughout one or multiple RAN nodes. The DUs 186 may be implemented to communicate with one or more RUs 180.

In some implementations, one or more wireless nodes such as the UEs 104 include a light adaptation component 140 configured to initiate beam reports for events detected at the UE 104. The light adaptation component 140 includes a subBWP configuration component 142, a PUCCH configuration component 144, a subBWP switching component 146, and a PUCCH transmit (Tx) component 148. The subBWP configuration component 142 is configured to obtain a configuration of a plurality of subBWPs within a single bandwidth part, the subBWPs having different bandwidths. The PUCCH configuration component 144 is configured obtain a configuration of a plurality of PUCCH resource sets, the configuration having an indication of whether each PUCCH resource set or each PUCCH resource in the plurality of PUCCH resource sets is valid for one or more of the subBWPs. The subBWP switching component 146 is configured to obtain an indication that one of the subBWPs is an active subBWP. For example, the first message may be a physical uplink control channel (PUCCH) that indicates that an event has been detected and requests uplink scheduling for a beam report. The PUCCH Tx component 148 is configured to output a PUCCH based on the active subBWP and based on whether the PUCCH resource set or the PUCCH resource is valid for the active subBWP.

In some implementations, one or more of wireless nodes such as the network entities including a base station 102 may include a light adaptation component 120. In particular, the light adaptation component 120 is configured to configure a UE with PUCCH resources for use with light adaptation. The light adaptation component 120 component 120 includes a subBWP configuration component 122, a PUCCH configuration component 124, a subBWP switching component 126, and a PUCCH receive (Rx) component 128. The subBWP configuration component 122 is configured to output a configuration of a plurality of subBWPs within a single bandwidth part, the subBWPs having different bandwidths. The PUCCH configuration component 124 is configured to output a configuration of a plurality of PUCCH resource sets, the configuration having an indication of whether each PUCCH resource set or a PUCCH resource in the plurality of PUCCH resource sets is valid for one or more of the subBWPs. The subBWP switching component 126 is configured to output an indication that one of the subBWPs is an active subBWP. The PUCCH receive (Rx) component 128 is configured to obtain a PUCCH based on the active subBWP and based on whether the PUCCH resource set or the PUCCH resource is valid for the active subBWP.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 116 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 118 (such as X2 interface). The third backhaul links 118 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station may utilize beamforming 182 with the UE 104 to compensate for the path loss and short range. For example, the base station 102 may use beamforming 182 to transmit beams 182a and the UE 104 may utilize beamforming 182 to transmit beams 182 b.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 6G, the concepts described herein may be applicable to other similar areas, such as 5G NR, LTE, LTE-A, CDMA, GSM, and other wireless technologies including future wireless technologies.

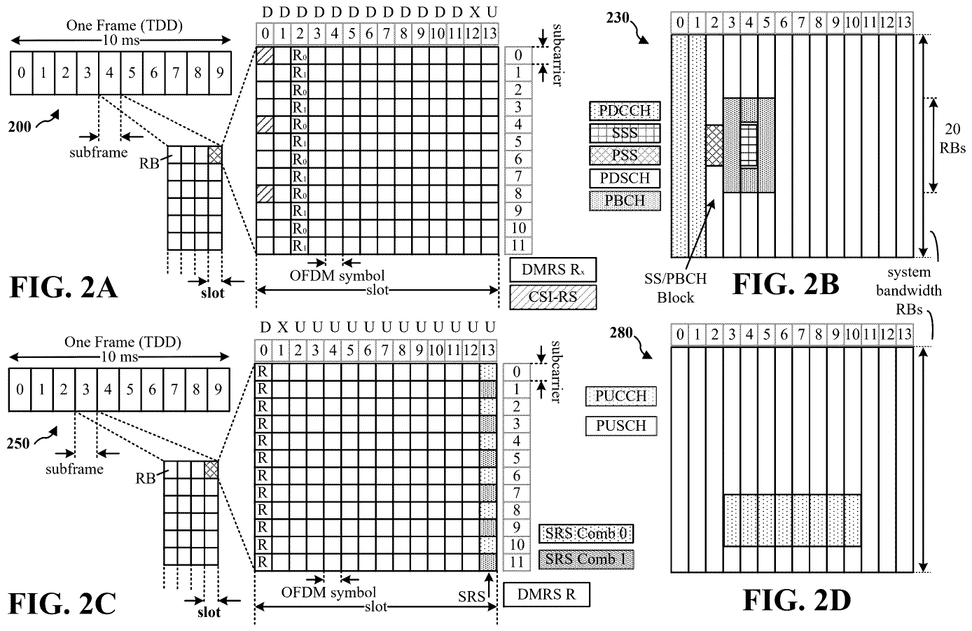

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one. In an aspect, a narrow bandwidth part (NBWP) refers to a BWP having a bandwidth less than or equal to a maximum configurable bandwidth of a BWP. The bandwidth of the NBWP is less than the carrier system bandwidth.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ*15} kHz, where μis the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DMRS) (indicated as Rₓ for one particular configuration, where 100x is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a L1 identity. A secondary synchronization signal (SSS) may be within symbol 4 of particular subframes of a frame. The SSS is used by a UE to determine a L1 cell identity group number and radio frame timing. Based on the L1 identity and the L1 cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

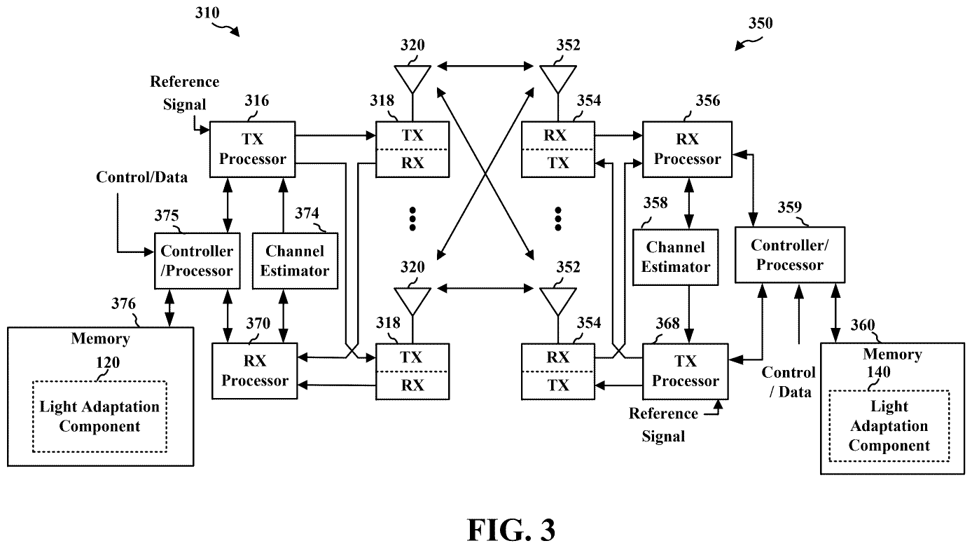

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission. In a split architecture, the transmitters/receivers 318 may be located in an RU 180, and the Tx processor 316, channel estimator 374, controller/processor 375, and Rx processor 370 may be located in a DU 186.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with the light adaptation component 140 of FIG. 1. For example, the memory 360 may include executable instructions defining the light adaptation component 140. The TX processor 368, the RX processor 356, and/or the controller/processor 359 may be configured to execute the light adaptation component 140.

At least one of the TX processor 316, the RX processor 370, and the controller/processor 375 may be configured to perform aspects in connection with the light adaptation component 120 of FIG. 1. For example, the memory 376 may include executable instructions defining the light adaptation component 120. The TX processor 316, the RX processor 370, and/or the controller/processor 375 may be configured to execute the light adaptation component 120.

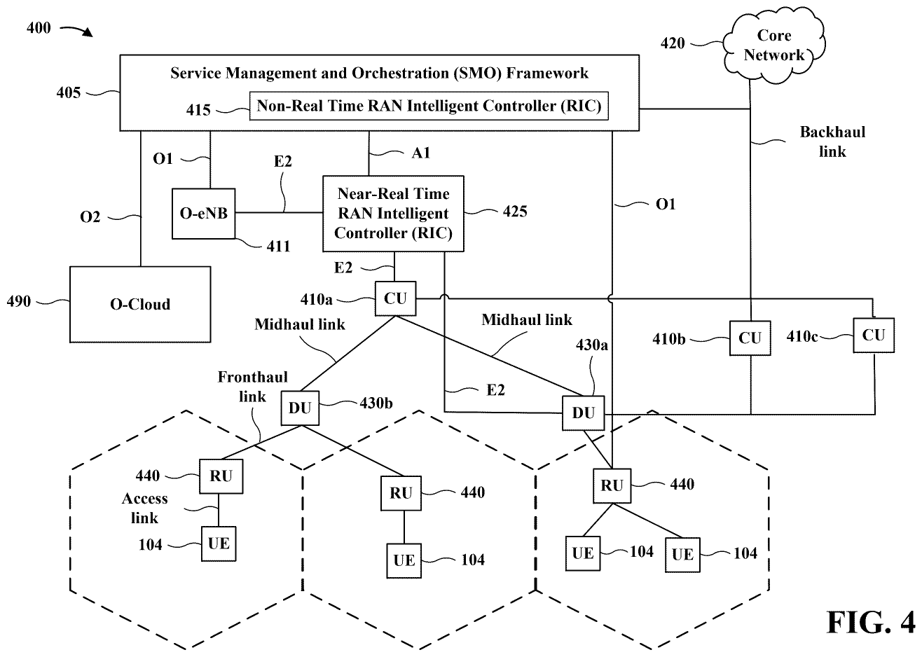

FIG. 4 is a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

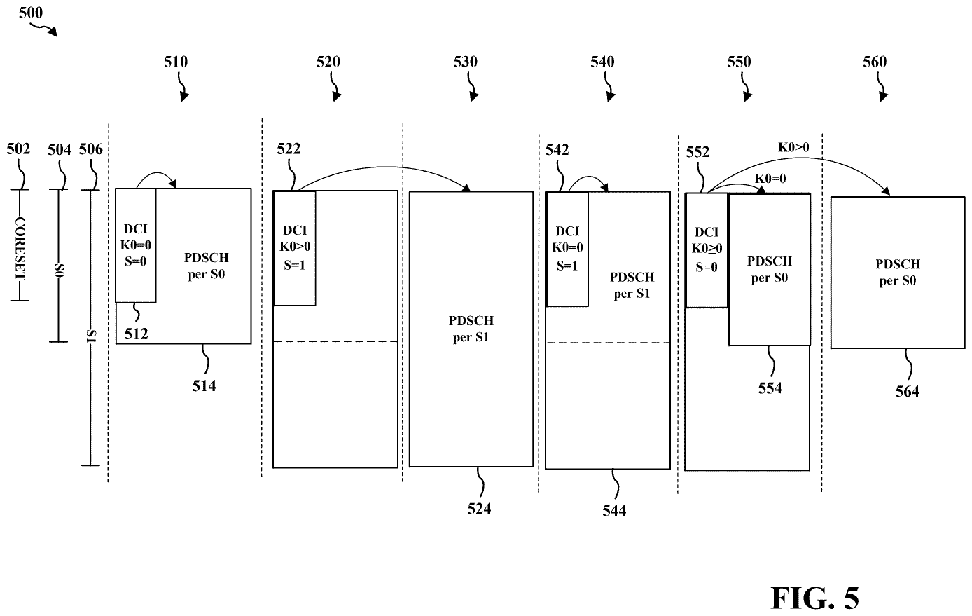

FIG. 5 is a diagram 500 illustrating changes during light adaptation over multiple slots. A UE may be configured with a BWP configuration that specifies a control resource set (CORESET) 502 that the UE monitors for DCI. The BWP configuration may also specify DCI field sizes that are used to blind decode PDCCH candidates in the CORESET. The UE may also be configured with a subBWP configuration that defines a first subBWP (S0) 504 and a second subBWP (S1) 506. For instance, S0 may have a smaller bandwidth than S1. That is, S0 may have a scheduling restriction that limits the bandwidth on which a transmission (e.g., PDSCH) can be scheduled. In contrast, S1 may use the full bandwidth of the BWP.

In a first slot 510, the first subBWP (S0) may be active. A DCI may indicate an active subBWP for a transmission (e.g., a PDSCH). The DCI may also indicate a time domain offset (K0), which indicates in which slot the transmission is scheduled. In some implementations, the first subBWP may be associated with a shorter switching time and smaller possible value of K0.

A first DCI 512 may be received in slot 510 and indicate K0=0 and S=0 meaning the PDSCH 514 is transmitted in the same slot and there is no change in subBWP. A second DCI 522 may be received in slot 520 and indicate K0>0 and S=1 meaning the transmission is scheduled for a later slot and the subBWP is changed. Accordingly, the PDSCH 524 may be received in slot 530 based on the second subBWP (S1). The larger K0 value may accommodate a subBWP switching time. A third DCI 542 may be received in slot 540 and indicate K0=0 and S=1 meaning the PDSCH 544 is scheduled in the same slot and there is no change in subBWP. A fourth DCI 552 may be received in slot 550 and indicate K0≥0 and S=0 meaning a switch to the first subBWP (S0). If K0=0, the PDSCH 554 may be scheduled in the slot 550. In this case, the S0 may be associated with a subBWP switching time that is less than 1 slot, allowing the UE to switch subBWP and receive the PDSCH 554 in the same slot. If K0>0, the PDSCH 564 may be scheduled in slot 560.

Notably, each of the DCIs 512, 522, 542, and 552 may be received on the same CORESET 502. Accordingly, even if the UE misses one of the DCIs 522 or 552 that change the subBWP, the UE will still be able to receive the next DCI.

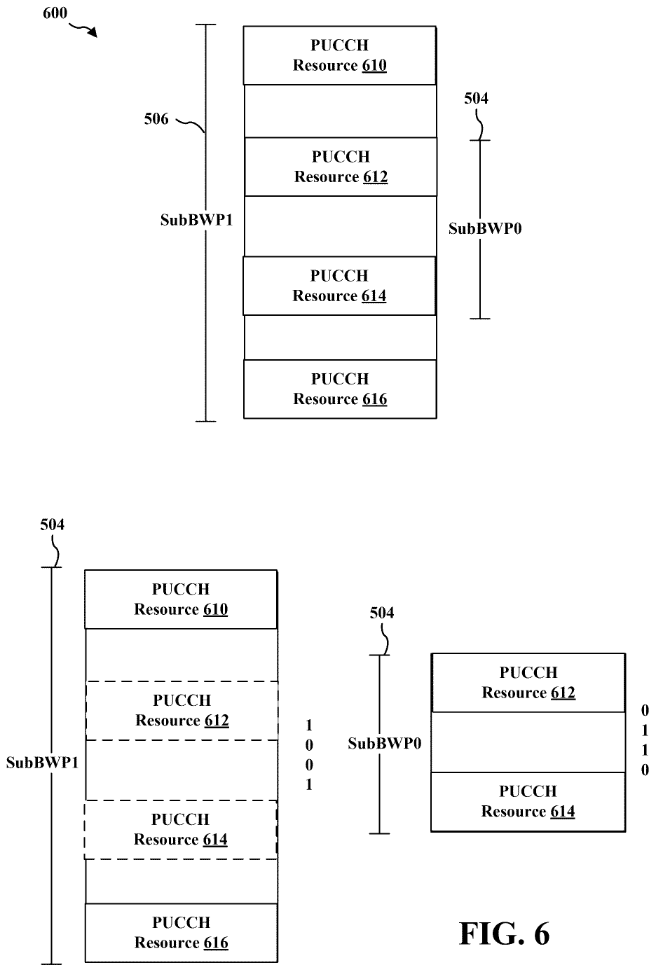

FIG. 6 is a diagram illustrating a PUCCH configuration 600 applied to different subBWPs. Because light adaptation aims to minimize the reconfigurations and updates when switching subBWPs, the PUCCH configuration may also minimize reconfiguration. For instance, the PUCCH configuration may be defined for the BWP and adapted based on the active subBWP. Further, the PUCCH configuration may allow a UE to transmit PUCCH on a resource that is monitored for either subBWP. Accordingly, the UE may use the PUCCH to transmit an indication when the UE detects an OOS condition.

In the illustrated example, the PUCCH configuration 600 defines multiple PUCCH resources 610, 612, 614, and 616. For example, the PUCCH configuration 600 may define the PUCCH resources for the BWP and outside of the subBWPs The PUCCH resources may be grouped into PUCCH resource sets. The PUCCH configuration 600 may also indicate whether each PUCCH resource set or each PUCCH resource is valid for each of the subBWPs (e.g., S0 and S1). For instance, PUCCH resource 612 and 614 may be valid for S0 504, and PUCCH resource 610 and 616 may be valid for S0 506.

In some implementations, the PUCCH configuration 600 may indicate validity for each subBWP as a bitmap, where each bit indicates whether a PUCCH resource set or PUCCH resource is valid for the subBWP. For instance, the PUCCH configuration 600 may indicate “0110” for S0 and indicate “1001” for S1. In some implementations, the configuration of each PUCCH resource may indicate whether the PUCCH resource is valid for each subBWP. In some implementations, a rule may specify that when the active subBWP has a scheduling limitation, any PUCCH resource outside of the limited bandwidth is invalid. For a subBWP that has the same bandwidth as the BWP, all of the configured PUCCH resources may be valid.

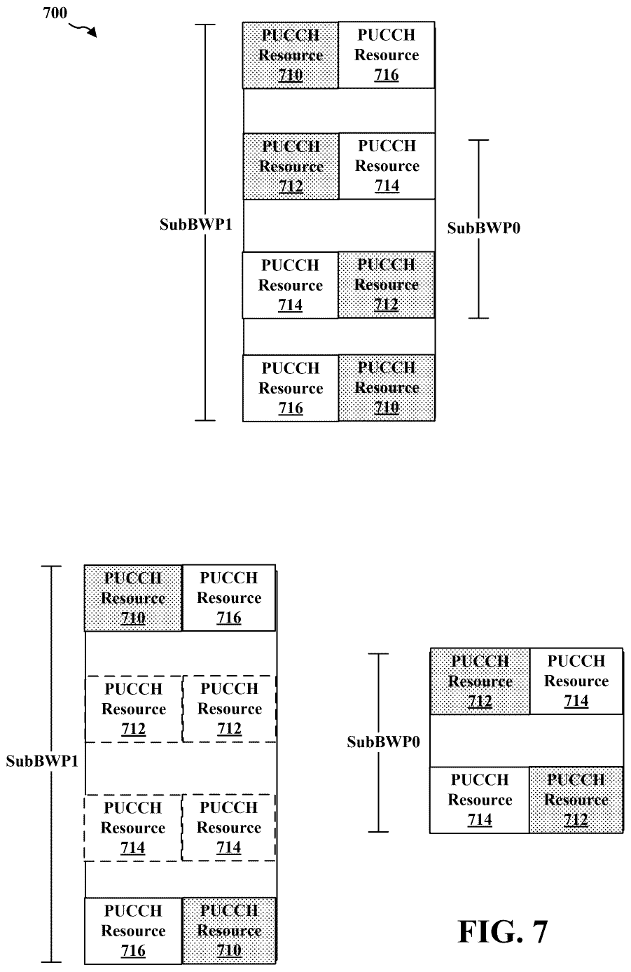

FIG. 7 is a diagram illustrating a PUCCH configuration 700 with frequency hopping applied to different subBWPs. Similar to the PUCCH configuration 600, the PUCCH configuration 700 may define multiple PUCCH resources 710, 712, 714, 716, which may be grouped into PUCCH resource sets. With frequency hopping, each PUCCH resource 710, 712, 714, 716 may shift over time (i.e., based on a slot). In an aspect, the frequency hopping may depend on the configured subBWPs. For example, each hop of a PUCCH resource may remain within the same subBWP. For instance, in order to provide a valid PUCCH resource after the hop for S0 504, the PUCCH resource 712 may change to the frequency corresponding to PUCCH resource 714.

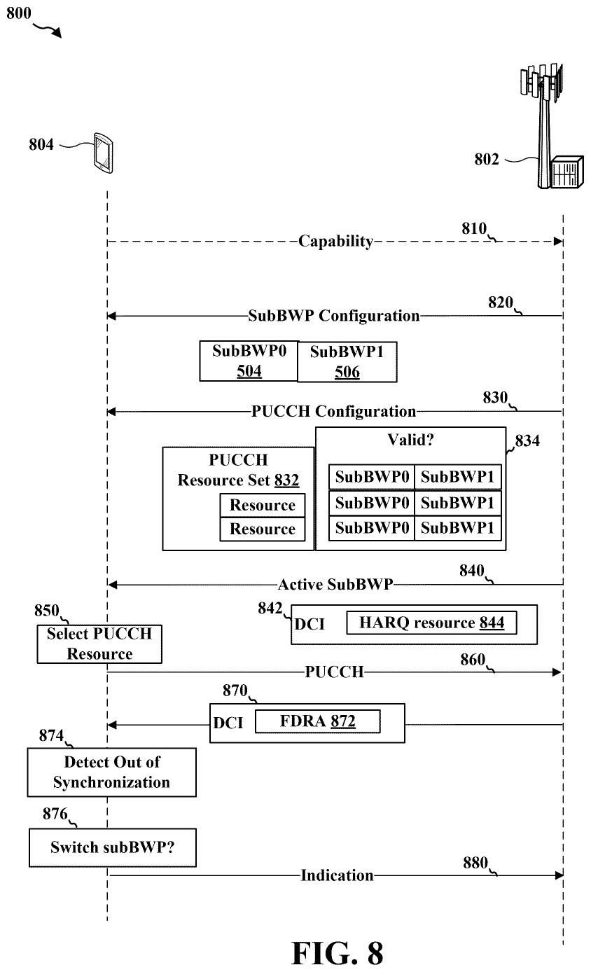

FIG. 8 is a message diagram 800 illustrating various messages for PUCCH configuration with light adaptation. A wireless node such as a UE 804 may be configured with a subBWP configuration and a PUCCH configuration that can be used to transmit a PUCCH. A wireless node such as a network node 802 may configure the UE 804 and receive the PUCCH.

In some implementations, the UE 804 may transmit a capability message 810 that indicates a capability associated with a maximum quantity of subBWPs. For example, the capability may indicate a maximum quantity of subBWPs that the UE 804 can support. For instance, the UE may support multiple subBWPs by storing configuration parameters in a memory such that the parameters can be quickly switched. In some implementations, the network node 802 may configure a quantity of PUCCH resource sets based on the capability.

The network node 802 may transmit a subBWP configuration 820. The subBWP configuration 820 may define a plurality of subBWPs within a single BWP, the subBWPs having different bandwidths. For instance, the subBWP configuration 820 may define the subBWP0 504 and the subBWO1 506 as discussed above with respect to FIG. 5.

The network node 802 may transmit a PUCCH configuration 830 that defines a plurality of PUCCH resource sets 832. For instance, a PUCCH resource set 832 may include the PUCCH resources 612 and 614. The PUCCH configuration 830 may have an indication 834 of whether each PUCCH resource set 832 or each PUCCH resource (e.g., 712, 714) in the plurality of PUCCH resource sets is valid for one or more of the subBWPs. For example, the indication 834 may be a bitmap in which each bit of the bitmap indicates a valid status or an invalid status for each PUCCH resource set or each PUCCH resource for each subBWP. As another example, the indication 834 may include an indication of one or more valid subBWPs for each PUCCH resource. As another example, the indication 834 may indicate that any PUCCH resource within a bandwidth of the subBWP is valid.

The network node 802 may transmit an indication 840 that one of the subBWPs is an active subBWP. For example, the indication 840 may be a DCI 842. As discussed above with respect to FIG. 5, a DCI may indicate the active subBWP and schedule a transmission. A DCI may also indicate a hybrid automatic repeat request (HARQ) resource 844 for the UE to transmit an acknowledgment of the scheduled transmission. In some implementations, the HARQ resource 844 is indicated in a PUCCH resource indicator (PRI) field or PDSCH-to-HARQ_feedback timing indicator field of the DCI 842. For instance, a PRI field may include a value that corresponds to a codepoint that is mapped to a configured PUCCH resource. In some implementations, because not all of the configured PUCCH resources are valid for the active subBWP, invalid values of the PRI field are not expected. The HARQ resource 844 may indicate a codepoint that is mapped to one of the configured PUCCH resources and has a value that corresponds to a valid PUCCH resource for the active subBWP. In some implementations, the HARQ resource 844 may indicate a codepoint that is mapped to only valid PUCCH resources for the active subBWP. For instance, the HARQ resource 844 may indicate the second configured PUCCH resource 714 that is valid for the active subBWP (e.g., S0). The HARQ resource 844 field of the DCI 842 may have the same size regardless of which subBWP is active.

At block 850, the UE 804 may select a PUCCH resource for transmission of a PUCCH based on the active subBWP and based on whether the PUCCH resource set or the PUCCH resource is valid for the active subBWP. For instance, where the PUCCH includes an acknowledgment of a resource scheduled by the DCI 842, the UE 804 may select the PUCCH resource indicated by the HARQ resource 844. As another example, if the UE 804 wants to transmit a scheduling request (SR), the UE 804 may select a valid PUCCH resource based on the active subBWP.

The UE 804 may transmit the PUCCH 860. For example, the UE 804 may transmit the PUCCH 860 based on the active subBWP and based on whether the PUCCH resource set or the PUCCH resource is valid for the active subBWP. For instance, the UE 804 may transmit the PUCCH 860 on the PUCCH resource selected in block 850.

In some implementations, a UE 804 may receive a DCI 870 that indicates a transmission outside of a bandwidth of the active subBWP. For instance, the DCI 870 may include a frequency domain resource allocation (FDRA) 872 that indicates resources outside of the bandwidth of the active subBWP. In block 874, the UE 804 may detect an out of synchronization event. That is, the UE 804 may be out of synchronization with the network node 802 with respect to the active BWP. For instance, the UE 804 may detect the out of synchronization event in response to the FDRA 872 indicating resources outside of the active subBWP. For example, the UE 804 may assume the active BWP is subBWP0 504 based on a previous DCI. The FDRA 872, however, may indicate resources that are in subBWP1 506 and outside of subBWP0 504. The UE 804 may determine that the network has switched to subBWP1 506 but the UE missed an indication 840 of the active subBWP.

In some implementations, the UE 804 may determine whether to switch the active subBWP in response to detecting an out of synchronization event. For instance, depending on the timeline for the active subBWP, a transmission scheduled by the DCI 870 or a corresponding HARQ resource may be after a switching time for the UE 804. Accordingly, the UE 804 may be able to switch the active subBWP of the network node 802 and transmit an indication 880 on a valid PUCCH resource of the active subBWP of the network node 802. The indication 880 may indicate whether the UE 804 received the transmission (e.g., PDSCH) and that the UE 804 was out of synchronization with respect to the active BWP. When the UE 804 is unable to switch the active subBWP before a transmission and/or HARQ resource scheduled by the DCI 870, the UE 804 may not switch the active subBWP. Instead, the UE 804 may transmit the indication 880 on a valid PUCCH resource for the active subBWP of the UE 804. In some implementations, at least one common resource of the configured PUCCH resources is valid for all of the configured subBWPs. The UE 804 may transmit the indication 880 on the common resource. In some implementations, the UE 804 may transmit the indication 880 on the common resource regardless of whether the UE could switch the active subBWP prior to transmitting the indication 880.

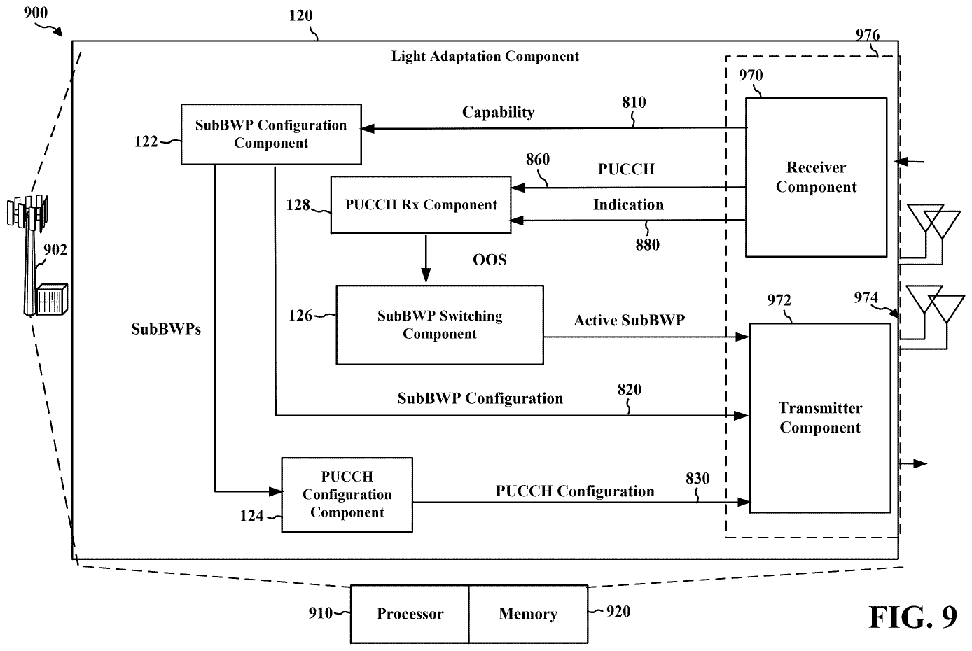

FIG. 9 is a conceptual flow diagram 900 illustrating the data flow between different means/components in an example network entity 902 including a light adaptation component 120. For example, the network entity 902 may be an example of a network node such as the base station 102 (FIG. 1) including the light adaptation component 120. In some implementations, the light adaptation component 120 may be implemented by the memory 376 and the TX processor 316, the RX processor 370, and/or the controller/processor 375 of FIG. 3. For example, the memory 376 may store executable instructions defining the light adaptation component 120 and the TX processor 316, the RX processor 370, and/or the controller/processor 375 may execute the instructions. In other implementations, the light adaptation component 120 may be implemented on computing resources including one or more processors 910 and one or more memories 920. For example, the light adaptation component 120 may be implemented on a virtual DU in a datacenter.

As discussed with respect to FIG. 1, the light adaptation component 120 may include the subBWP configuration component 122, the PUCCH configuration component 124, the subBWP switching component 126, and the PUCCH Rx component 128.

The network entity 902 may include a receiver component 970, which may include, for example, a radio frequency (RF) receiver for receiving the signals described herein. For example, receiver component 970 may receive the capability message 810, the PUCCH 860, and/or the indication 880. The network entity 902 may include a transmitter component 972, which may include, for example, an RF transmitter for transmitting the signals described herein. The transmitter component 972 may output RF signals to one or more antennas 974. In an aspect, the receiver component 970 and the transmitter component 972 may be co-located in a transceiver 976, which may correspond to the TX/RX 318 in FIG. 3.

The subBWP configuration component 122 may obtain the capability message 810 from the receiver component 970. The subBWP configuration component 122 may determine a number of subBWPs to configure based on the capability message 810. For example, the quantity of subBWPs or quantity of PDCCH resource sets indicated by the capability message 810 may impose a limit on the number of subBWP configurations. In some implementations, the subBWP configuration component 122 may select two subBWPs to configure. For example, one subBWP may be a limited bandwidth subBWP (e.g., S0) having a bandwidth less than the BWP, and another subBWP may use the full bandwidth of the BWP. In some implementations, additional subBWPs with limited bandwidth may be configured, for example, based on category of UE, expected traffic type, or power state. The subBWP configuration component 122 may output the subBWP configuration 820 for transmission via the transmitter component 972. For example, the subBWP configuration 820 may be an RRC message or information element thereof. The subBWP configuration component 122 may output the subBWPs to the PUCCH configuration component.

The PUCCH configuration component 124 may obtain configured subBWPs from the subBWP configuration component 122. The PUCCH configuration component 124 may determine PUCCH resources. For example, the PUCCH resources may be based on available PUCCH resources and/or resource allocations to other UEs. The PUCCH configuration component 124 may also determine whether frequency hopping applies to the PUCCH resources. The PUCCH configuration component 124 may determine whether each PUCCH resource is valid for each configured subBWP. In some implementations, any PUCCH resource within a subBWP is valid when that subBWP is active. In other implementations, the PUCCH configuration component 124 may select PUCCH resources, for example, to limit the number of valid PUCCH resources and maintain a consistent number of codepoints and PRI field size. The PUCCH configuration component 124 may generate a PUCCH configuration 830. The PUCCH configuration component 124 may output the PUCCH configuration 830 for transmission via the transmitter component 972. For example, the PUCCH configuration 830 may be an RRC message or information element thereof. In some implementations, the PUCCH configuration 830 may include a MAC-CE that downselects configured PUCCH resources that are mapped to codepoints.

The subBWP switching component 126 is configured to select a subBWP. For example, the subBWP switching component 126 may select a configured subBWP for communications with the UE 804 based on, for example, a downlink buffer size, a reported uplink buffer size, traffic types, or other scheduling considerations. The subBWP switching component 126 may output an indication 840 of the active subBWP for transmission via the transmitter component 972. For example, the indication 840 of the active subBWP may be the DCI 842. In some implementations, the DCI 842 may be a modification of an existing DCI format for scheduling a transmission. The DCI format may include an additional field to indicate the active subBWP, or an existing field may be interpreted differently to indicate the active subBWP. In some implementations, the subBWP switching component 126 may obtain an OOS indication from the PUCCH Rx component 128. The subBWP switching component 126 may remedy an OOS issue by transmitting another indication 840 of an active subBWP.

The PUCCH Rx component 128 is configured to obtain a PUCCH 860 based on the active subBWP and based on whether the PUCCH resource set or the PUCCH resource is valid for the active subBWP. For example, the PUCCH Rx component 128 may configure the receiver component 970 to monitor the valid PUCCH resources corresponding to an active BWP of a UE 804. The PUCCH Rx component 128 may decode a received PUCCH 860. For example, the receiver PUCCH 860 may include any uplink control information such as HARQ Ack or Nack, scheduling requests, or channel state information. In some implementations, the valid PUCCH resources include a common resource that is valid for all of the configured subBWPs. In some implementations, the PUCCH 860 may include an indication 880 that a UE is out of synchronization with the network entity 902 with respect to the active subBWP. The PUCCH Rx component 128 may output an OOS indication to the subBWP switching component in response to the indication 880.

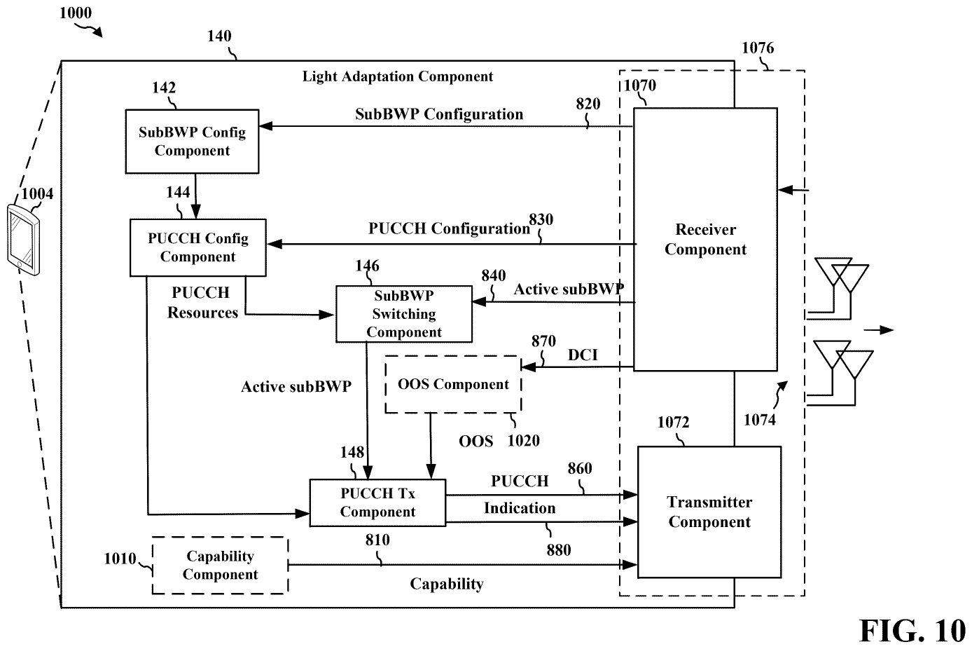

FIG. 10 is a conceptual data flow diagram 1000 illustrating the data flow between different means/components in an example UE 1004 including a light adaptation component 140. For example, the UE 1004 may be an example of a wireless node such as the UE 104 (FIG. 1) including the light adaptation component 140. The light adaptation component 140 may be implemented by the memory 360 and the TX processor 368, the RX processor 356, and/or the controller/processor 368 of FIG. 3. For example, the memory 360 may store executable instructions defining the light adaptation component 140 and the TX processor 368, the RX processor 356, and/or the controller/processor 359 may execute the instructions.

The UE 1004 may include a receiver component 1070, which may include, for example, a radio frequency (RF) receiver for receiving the signals described herein. The UE 1004 may include a transmitter component 1072, which may include, for example, an RF transmitter for transmitting the signals described herein. The transmitter component 1072 may output RF signals to one or more antennas 1074. In an aspect, the UE 1004 and the transmitter component 1072 may be co-located in a transceiver 1076, which may correspond to the TX/RX 354 in FIG. 3.

As discussed with respect to FIG. 1, the light adaptation component 140 may include the subBWP configuration component 142, the PUCCH configuration component 144, the subBWP switching component 146, and the PUCCH Tx component 148. In some implementations, the light adaptation component 140 may optionally include a capability component 1010.

The receiver component 1070 may receive signals from a network entity such as a base station 102. For example, the receiver component 1070 may receive the subBWP configuration 820, the PUCCH configuration 830, the indication 840 of the active subBWP, and/or the DCI 870. The receiver component 1070 may provide the subBWP configuration 820 to the subBWP configuration component 142. The receiver component 1070 may provide the PUCCH configuration 830 to the PUCCH configuration component 144. The receiver component 1070 may provide the indication 840 of the active subBWP and/or the DCI 870 to the subBWP switching component 146.

In some implementations, the optional capability component 1010 may be configured to output for transmission a capability associated with a maximum quantity of subBWPs. For example, the capability component 1010 may output the capability message 810 as an RRC message for transmission by the transmitter component 1072.

The subBWP configuration component 142 may obtain the subBWP configuration 820 via the receiver component 1070. The subBWP configuration component 142 may determine the bandwidth associated with each subBWP. The subBWP configuration component 142 may configure the receiver component 1070 with a set of parameters corresponding to each subBWP. The subBWP configuration component 142 may output the subBWPs to the PUCCH configuration component 144 and/or the subBWP switching component 146.

The PUCCH configuration component 144 may obtain the PUCCH configuration 830 via the receiver component 1070. The PUCCH configuration component 144 may determine the valid PUCCH resources for each configured subBWP. The PUCCH configuration component 144 may output the valid PUCCH resources to the PUCCH Tx component 148 and/or the subBWP switching component 146.

The subBWP switching component 146 may obtain the indication 840 of the active subBWP via the receiver component 1070. For example, the subBWP switching component 146 may obtain the DCI 842 and determine the S value that indicates the active subBWP. The subBWP switching component 146 may output the active subBWP to the PUCCH Tx component 148.

The PUCCH Tx component 148 may obtain the active subBWP from the subBWP switching component 146. The PUCCH Tx component 148 may select a valid PUCCH resource based on the active subBWP and the PUCCH configuration. For example, the PUCCH Tx component 148 may map a value of HARQ resource 844 (e.g., a PRI field) of the DCI 842 to the valid PUCCH resource. The PUCCH Tx component 148 may output the PUCCH for transmission via the transmitter component 1072.

In some implementations, the optional OOS component 1020 is configured to detect an out of synchronization condition with respect to the active subBWP. The OOS component 1020 may obtain the DCI 870 via the receiver component 1070. The DCI 870 may indicate a transmission outside of a bandwidth of the active subBWP. The OOS component 1020 may output a OOS signal to the PUCCH Tx component 148 to cause the PUCCH Tx component 148 to output an indication 880 for transmission via the transmitter component 1072.

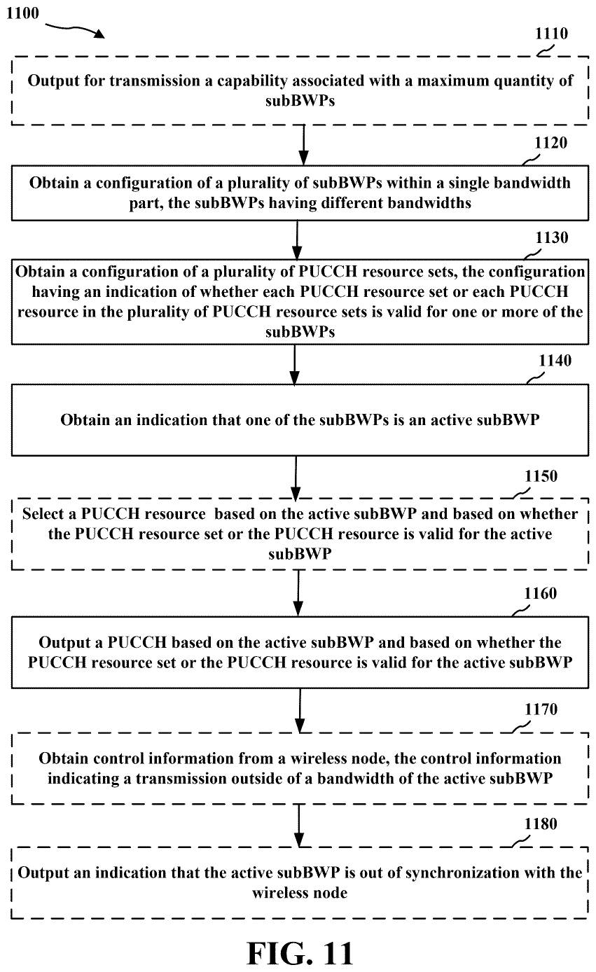

FIG. 11 is a flowchart of an example method 1100 for a wireless node such as a UE to transmit a PUCCH based on an active subBWP using light adaptation. The method 1100 may be performed by a UE (such as the UE 104, which may include the memory 360 and which may be the entire UE 104 or a component of the UE 104 such as the light adaptation component 140, TX processor 368, the RX processor 356, or the controller/processor 359). The method 1100 may be performed by the light adaptation component 140 in communication with the light adaptation component 120 at a network entity. Optional blocks are shown with dashed lines.

At block 1110, the method 1100 may optionally include outputting for transmission a capability associated with a maximum quantity of subBWPs. In some implementations, for example, the UE 104, the TX processor 368 or the controller/processor 359 may execute the light adaptation component 140 or the capability component 1010 to output for transmission a capability associated with a maximum quantity of subBWPs. Accordingly, the UE 104, the TX processor 368, or the controller/processor 359 executing the light adaptation component 140 or the capability component 1010 may provide means for outputting for transmission a capability associated with a maximum quantity of subBWPs.

At block 1120, the method 1100 includes obtaining a configuration of a plurality of subBWPs within a single bandwidth part, the subBWPs having different bandwidths. In some implementations, for example, the UE 104, the RX processor 356 or the controller/processor 359 may execute the light adaptation component 140 or the subBWP configuration component 142 to obtain a configuration 820 of a plurality of subBWPs within a single bandwidth part, the subBWPs having different bandwidths. Accordingly, the UE 104, the RX processor 359, or the controller/processor 359 executing the light adaptation component 140 or the subBWP configuration component 142 may provide means for obtaining a configuration of a plurality of subBWPs within a single bandwidth part, the subBWPs having different bandwidths.

At block 1130, the method 1100 includes obtaining a configuration of a plurality of PUCCH resource sets, the configuration having an indication of whether each PUCCH resource set or each PUCCH resource in the plurality of PUCCH resource sets is valid for one or more of the subBWPs. In some implementations, for example, the UE 104, the RX processor 356 or the controller/processor 359 may execute the light adaptation component 140 or the PUCCH configuration component 144 to obtain a configuration 830 of a plurality of PUCCH resource sets 832, the configuration 830 having an indication 834 of whether each PUCCH resource set or each PUCCH resource in the plurality of PUCCH resource sets is valid for one or more of the subBWPs. In some implementations, the indication is a bitmap in which each bit of the bitmap indicates a valid status or an invalid status for each PUCCH resource set or each PUCCH resource for each subBWP. In some implementations, the indication is an indication of one or more valid subBWPs for each PUCCH resource. In some implementations, the indication indicates that any PUCCH resource within a bandwidth of the subBWP is valid. Accordingly, the UE 104, the RX processor 359, or the controller/processor 359 executing the light adaptation component 140 or the PUCCH configuration component 144 may provide means for obtaining a configuration of a plurality of PUCCH resource sets, the configuration having an indication of whether each PUCCH resource set or each PUCCH resource in the plurality of PUCCH resource sets is valid for one or more of the subBWPs.

At block 1140, the method 1100 includes obtaining an indication that one of the subBWPs is an active subBWP. In some implementations, for example, the UE 104, the RX processor 356 or the controller/processor 359 may execute the light adaptation component 140 or the subBWP switching component 146 to obtain the indication 840 that one of the subBWPs is an active subBWP. Accordingly, the UE 104, the RX processor 359, or the controller/processor 359 executing the light adaptation component 140 or the subBWP switching component 146 may provide means for obtaining an indication that one of the subBWPs is an active subBWP.

At block 1150, the method 1100 may optionally include selecting a PUCCH resource based on the active subBWP and based on whether the PUCCH resource set or the PUCCH resource is valid for the active subBWP. In some implementations, for example, the UE 104, the TX processor 368 or the controller/processor 359 may execute the light adaptation component 140 or the PUCCH Tx component 148 to select a PUCCH resource based on the active subBWP and based on whether the PUCCH resource set or the PUCCH resource is valid for the active subBWP. In some implementations, the block 1150 may optionally include obtaining control information (e.g., DCI 842) indicating a HARQ resource 844 as a codepoint. In some implementations, a HARQ resource indicated by the control information indicates a codepoint that is mapped to the configured PUCCH resources and has a value that corresponds to a valid PUCCH resource for the active subBWP, so the the valid PUCCH resource for the active subBWP is selected. In some implementations, a HARQ resource indicated by the control information indicates a codepoint that is mapped to only valid PUCCH resources for the active subBWP, so one of the valid PUCCH resources for the active subBWP indicated by a value of the codepoint is selected. Accordingly, the UE 104, the TX processor 368, or the controller/processor 359 executing the light adaptation component 140 or the PUCCH Tx component 148 may provide means for selecting a PUCCH resource based on the active subBWP and based on whether the PUCCH resource set or the PUCCH resource is valid for the active subBWP.

At block 1160, the method 1100 includes outputting a PUCCH based on the active subBWP and based on whether the PUCCH resource set or the PUCCH resource is valid for the active subBWP. In some implementations, for example, the UE 104, the TX processor 368 or the controller/processor 359 may execute the light adaptation component 140 or the PUCCH Tx component 148 to output a PUCCH based on the active subBWP and based on whether the PUCCH resource set or the PUCCH resource is valid for the active subBWP. Accordingly, the UE 104, the TX processor 368, or the controller/processor 359 executing the light adaptation component 140 or the PUCCH Tx component 148 may provide means for outputting a PUCCH based on the active subBWP and based on whether the PUCCH resource set or the PUCCH resource is valid for the active subBWP.

At block 1170, the method 1100 may optionally include obtaining control information from a wireless node, the control information indicating a transmission outside of a bandwidth of the active subBWP. In some implementations, for example, the UE 104, the RX processor 356 or the controller/processor 359 may execute the light adaptation component 140 or the OOS component 1020 to obtain control information (e.g., DCI 870) from a wireless node, the control information indicating a transmission outside of a bandwidth of the active subBWP. Accordingly, the UE 104, the RX processor 359, or the controller/processor 359 executing the light adaptation component 140 or the OOS component 1020 may provide means for obtaining control information from a wireless node, the control information indicating a transmission outside of a bandwidth of the active subBWP.

At block 1180, the method 1100 may optionally include outputting an indication that the active subBWP is out of synchronization with the wireless node. In some implementations, for example, the UE 104, the TX processor 368 or the controller/processor 359 may execute the light adaptation component 140 or the OOS component 1020 to output an indication 880 that the active subBWP is out of synchronization with the wireless node. In some implementations, a common resource of the plurality of PUCCH resource sets is valid for each of the subBWPs, and the indication that the active subBWP is out of synchronization with the wireless node is transmitted via the common resource. In some implementations, the block 1180 may optionally include switching the active subBWP to a configured subBWP including the bandwidth for the transmission. The transmission of the indication that the active subBWP is out of synchronization can be on a PUCCH resource selected based on a switching time and a scheduled PUCCH resource. Accordingly, the UE 104, the TX processor 368, or the controller/processor 359 executing the light adaptation component 140 or the OOS component 1020 may provide means for outputting an indication that the active subBWP is out of synchronization with the wireless node.

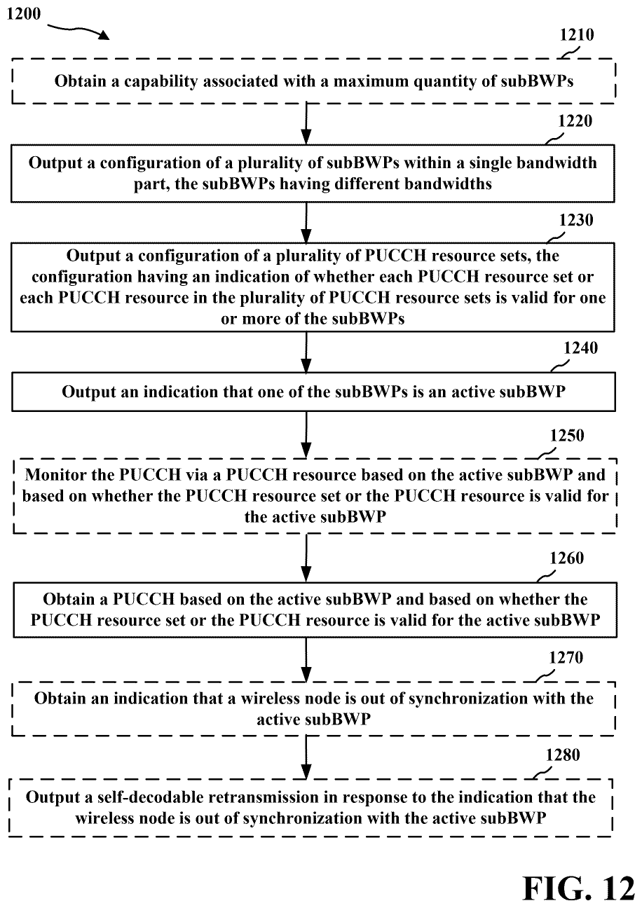

FIG. 12 is a flowchart of an example method 1200 for a wireless node such as a network entity to receive a PUCCH based on an active subBWP using light adaptation. The method 1200 may be performed by a network entity (such as the base station 102, which may include the memory 376 and which may be the entire base station 102 or a component of the base station such as the light adaptation component 120, TX processor 316, the RX processor 370, or the controller/processor 375). The method 1200 may be performed by the light adaptation component 120 in communication with the light adaptation component 140 at a UE. Optional blocks are shown with dashed lines.

At block 1210, the method 1200 may optionally include obtaining a capability associated with a maximum quantity of subBWPs. In some implementations, for example, the base station 102, the RX processor 370 or the controller/processor 375 may execute the light adaptation component 120 or the capability component 1010 to obtain a capability associated with a maximum quantity of subBWPs. Accordingly, the base station 102, the RX processor 370, or the controller/processor 375 executing the light adaptation component 120 or the capability component 1010 may provide means for obtaining a capability associated with a maximum quantity of subBWPs.

At block 1220, the method 1200 includes outputting a configuration of a plurality of subBWPs within a single bandwidth part, the subBWPs having different bandwidths. In some implementations, for example, the base station 102, the TX processor 316 or the controller/processor 375 may execute the light adaptation component 120 or the subBWP configuration component 122 to output a configuration 820 of a plurality of subBWPs within a single bandwidth part, the subBWPs having different bandwidths. Accordingly, the base station 102, the TX processor 316, or the controller/processor 375 executing the light adaptation component 120 or the subBWP configuration component 122 may provide means for outputting a configuration of a plurality of subBWPs within a single bandwidth part, the subBWPs having different bandwidths.

At block 1230, the method 1200 includes outputting a configuration of a plurality of PUCCH resource sets, the configuration having an indication of whether each PUCCH resource set or each PUCCH resource in the plurality of PUCCH resource sets is valid for one or more of the subBWPs. In some implementations, for example, the base station 102, the TX processor 316 or the controller/processor 375 may execute the light adaptation component 120 or the PUCCH configuration component 124 to output a configuration 830 of a plurality of PUCCH resource sets 832, the configuration 830 having an indication 834 of whether each PUCCH resource set or each PUCCH resource in the plurality of PUCCH resource sets is valid for one or more of the subBWPs. Accordingly, the base station 102, the TX processor 316, or the controller/processor 375 executing the light adaptation component 120 or the PUCCH configuration component 124 may provide means for outputting a configuration of a plurality of PUCCH resource sets, the configuration having an indication of whether each PUCCH resource set or each PUCCH resource in the plurality of PUCCH resource sets is valid for one or more of the subBWPs.

At block 1240, the method 1200 includes outputting an indication that one of the subBWPs is an active subBWP. In some implementations, for example, the base station 102, the TX processor 316 or the controller/processor 375 may execute the light adaptation component 120 or the subBWP switching component 126 to output the indication 840 that one of the subBWPs is an active subBWP. In some implementations, the indication 840 is a DCI including a HARQ resource. In some implementations, the block 1240 includes outputting control information indicating a HARQ resource as a codepoint that is mapped to one of the configured PUCCH resources and has a value that corresponds to a valid PUCCH resource for the active subBWP. In some implementations, the block 1240 includes outputting control information indicating a HARQ resource as a codepoint that is mapped to only valid PUCCH resources for the active subBWP. Accordingly, the base station 102, the TX processor 316, or the controller/processor 375 executing the light adaptation component 120 or the subBWP switching component 126 may provide means for outputting an indication that one of the subBWPs is an active subBWP.

At block 1250, the method 1200 may optionally include monitoring the PUCCH via a PUCCH resource based on the active subBWP and based on whether the PUCCH resource set or the PUCCH resource is valid for the active subBWP. In some implementations, for example, the base station 102, the RX processor 370 or the controller/processor 375 may execute the light adaptation component 120 or the PUCCH Rx component 128 to monitor the PUCCH via a PUCCH resource based on the active subBWP and based on whether the PUCCH resource set or the PUCCH resource is valid for the active subBWP. In some implementations, the PUCCH Rx component 128 may select the PUCCH resource based on the active subBWP and based on whether the PUCCH resource set or the PUCCH resource is valid for the active subBWP. Accordingly, the base station 102, the RX processor 370, or the controller/processor 375 executing the light adaptation component 120 or the PUCCH Rx component 128 may provide means for monitoring the PUCCH via a PUCCH resource based on the active subBWP and based on whether the PUCCH resource set or the PUCCH resource is valid for the active subBWP.

At block 1260, the method 1200 includes obtaining a PUCCH based on the active subBWP and based on whether the PUCCH resource set or the PUCCH resource is valid for the active subBWP. In some implementations, for example, the base station 102, the RX processor 370 or the controller/processor 375 may execute the light adaptation component 120 or the PUCCH Rx component 128 to obtain a PUCCH based on the active subBWP and based on whether the PUCCH resource set or the PUCCH resource is valid for the active subBWP. Accordingly, the base station 102, the RX processor 370, or the controller/processor 375 executing the light adaptation component 120 or the PUCCH Rx component 128 may provide means for obtaining a PUCCH based on the active subBWP and based on whether the PUCCH resource set or the PUCCH resource is valid for the active subBWP.

At block 1270, the method 1200 may optionally include obtaining an indication that the active subBWP is out of synchronization with the wireless node. In some implementations, for example, the base station 102, the RX processor 370 or the controller/processor 375 may execute the light adaptation component 120 or the PUCCH Rx component 128 to obtain an indication 880 that the active subBWP is out of synchronization with the wireless node. In some implementations, the indication that the wireless node is out of synchronization with the active subBWP is obtained via the common resource. Accordingly, the base station 102, the RX processor 370, or the controller/processor 375 executing the light adaptation component 120 or the PUCCH Rx component 128 may provide means for obtaining an indication that the active subBWP is out of synchronization with the wireless node.

At block 1280, the method 1200 may optionally include outputting a self-decodable retransmission in response to the indication that the wireless node is out of synchronization with the active subBWP. In some implementations, for example, the base station 102, the TX processor 316 or the controller/processor 375 may execute the light adaptation component 120 or the subBWP switching component 126 to output the self-decodable retransmission in response to the indication that the wireless node is out of synchronization with the active subBWP. Accordingly, the base station 102, the TX processor 316, or the controller/processor 375 executing the light adaptation component 120 or the subBWP switching component 126 may provide means for outputting a self-decodable retransmission in response to the indication that the wireless node is out of synchronization with the active subBWP.

In some cases, rather than actually transmitting a message, a device may have an interface to output a message for transmission (a means for outputting). For example, a processor may output a message, via a bus interface, to a radio frequency (RF) front end for transmission. Similarly, rather than actually receiving a message, a device may have an interface to obtain a message received from another device (a means for obtaining). For example, a processor may obtain (or receive) a message, via a bus interface, from an RF front end for reception. In some cases, the interface to output a message for transmission and the interface to obtain a message (which may be referred to as first and second interfaces herein) may be the same interface.

Means for obtaining, means for outputting, means for detecting, means for selecting, and/or means for monitoring may include any of the various processors and/or memories shown in FIG. 3. Means for receiving and/or means for transmitting may include any of the various processors, memories, and/or transceivers shown in FIG. 3.

The following numbered examples provide an overview of aspects of the present disclosure:
Example 1. An method of wireless communication at a wireless node, comprising: obtaining a configuration of a plurality of sub-bandwidth parts (subBWPs) within a single bandwidth part, the subBWPs having different bandwidths; obtaining a configuration of a plurality of physical uplink control channel (PUCCH) resource sets, the configuration having an indication of whether each PUCCH resource set or each PUCCH resource in the plurality of PUCCH resource sets is valid for one or more of the subBWPs; obtaining an indication that one of the subBWPs is an active subBWP; and outputting a PUCCH based on the active subBWP and based on whether the PUCCH resource set or the PUCCH resource is valid for the active subBWP.
Example 2. The method of example 1, further comprising outputting for transmission a capability associated with a maximum quantity of subBWPs, wherein the configuration of the plurality of PUCCH resource sets includes a quantity of PUCCH resource sets based on the capability.
Example 3. The method of example 1, further comprising selecting a PUCCH resource based on the active subBWP and based on whether the PUCCH resource set or the PUCCH resource is valid for the active subBWP, wherein the PUCCH is output for transmission via the selected PUCCH resource.
Example 4. The method of example 1, wherein the indication of whether each PUCCH resource set or each PUCCH resource in the plurality of PUCCH resource sets is valid for one or more of the subBWPs comprises a bitmap in which each bit of the bitmap indicates a valid status or an invalid status for each PUCCH resource set or each PUCCH resource for each subBWP.
Example 5. The method of example 1, wherein the indication of whether each PUCCH resource set or the PUCCH resource in the plurality of PUCCH resource sets is valid for one or more of the subBWPs includes an indication of one or more valid subBWPs for each PUCCH resource.
Example 6. The method of example 1, wherein the indication of whether each PUCCH resource set or each PUCCH resource in the plurality of PUCCH resource sets is valid for one or more of the subBWPs indicates that any PUCCH resource within a bandwidth of the subBWP is valid.
Example 7. The method of example 1, further comprising obtaining control information indicating a hybrid automatic repeat request (HARQ) resource as a codepoint that is mapped to the configured PUCCH resources and has a value that corresponds to a valid PUCCH resource for the active subBWP, wherein the PUCCH is output via the valid PUCCH resource for the active subBWP.
Example 8. The method of example 1, further comprising obtaining control information indicating a hybrid automatic repeat request (HARQ) resource as a codepoint that is mapped to only valid PUCCH resources for the active subBWP, wherein the PUCCH is output via one of the valid PUCCH resources for the active subBWP indicated by a value of the codepoint.
Example 9. The method of example 1, further comprising: obtaining control information from a wireless node, the control information indicating a transmission outside of a bandwidth of the active subBWP; and outputting for transmission an indication that the active subBWP is out of synchronization with the wireless node.
Example 10. The method of example 9, wherein a common resource of the plurality of PUCCH resource sets is valid for each of the subBWPs, wherein the indication that the active subBWP is out of synchronization with the wireless node is output for transmission via the common resource.
Example 11. The method of example 9, further comprising switching the active subBWP to a configured subBWP including the bandwidth for the output, wherein the output of the indication that the active subBWP is out of synchronization is on a PUCCH resource selected based on a switching time and a scheduled PUCCH resource.
Example 12. A method of wireless communication at a wireless node, comprising: outputting a configuration of a plurality of sub-bandwidth parts (subBWPs) within a single bandwidth part, the subBWPs having different bandwidths; outputting a configuration of a plurality of physical uplink control channel (PUCCH) resource sets, the configuration having an indication of whether each PUCCH resource set or a PUCCH resource in the plurality of PUCCH resource sets is valid for one or more of the subBWPs; outputting an indication that one of the subBWPs is an active subBWP; and obtaining a PUCCH based on the active subBWP and based on whether the PUCCH resource set or the PUCCH resource is valid for the active subBWP.
Example 13. The method of example 12, further comprising obtaining a capability associated with a maximum quantity of subBWPs for a wireless node, wherein the configuration of the plurality of PUCCH resource sets includes a quantity of PUCCH resource sets based on the capability.
Example 14. The method of example 12, wherein the indication of whether each PUCCH resource set or each PUCCH resource in the plurality of PUCCH resource sets is valid for one or more of the subBWPs comprises a bitmap in which each bit of the bitmap indicates a valid status or an invalid status for each PUCCH resource set or each PUCCH resource for each subBWP.
Example 15. The method of example 12, wherein the indication of whether each PUCCH resource set or each PUCCH resource in the plurality of PUCCH resource sets is valid for one or more of the subBWPs includes an indication of one or more valid subBWPs for each PUCCH resource.
Example 16. The method of example 12, wherein the indication of whether each PUCCH resource set or each PUCCH resource in the plurality of PUCCH resource sets is valid for one or more of the subBWPs indicates that any PUCCH resource within a bandwidth of the active subBWP is valid.
Example 17. The method of example 12, further comprising outputting control information indicating a hybrid automatic repeat request (HARQ) resource as a codepoint that is mapped to the configured PUCCH resources and has a value that corresponds to a valid PUCCH resource for the active subBWP, wherein the PUCCH is obtained via the valid PUCCH resource for the active subBWP.
Example 18. The method of example 12, further comprising outputting control information indicating a hybrid automatic repeat request (HARQ) resource as a codepoint that is mapped to only valid PUCCH resources for the active subBWP, wherein the PUCCH is obtained via one of the valid PUCCH resources for the active subBWP indicated by a value of the codepoint.
Example 19. The method of example 12, further comprising obtaining an indication that a wireless node is out of synchronization with the active subBWP.
Example 20. The method of example 19, wherein a common resource of the plurality of PUCCH resource sets is valid for each of the subBWPs, wherein the indication that the wireless node is out of synchronization with the active subBWP is obtained via the common resource.
Example 21. The method of example 19, further comprising outputting a self-decodable retransmission in response to the indication that the wireless node is out of synchronization with the active subBWP.
Example 22. The method of example 12, further comprising selecting a PUCCH resource to monitor for the PUCCH based on the active subBWP and based on whether the PUCCH resource set or the PUCCH resource is valid for the active subBWP.
Example 23 is an apparatus for wireless communications, comprising means for performing a method in accordance with any one of examples 1-11.
Example 24 is an apparatus for wireless communications, comprising means for performing a method in accordance with any one of examples 12-22.
Example 25 is a non-transitory computer-readable medium comprising instructions that, when executed by a wireless node (e.g., a UE), cause the wireless node to perform a method in accordance with any one of examples 1-11.
Example 26 is a non-transitory computer-readable medium comprising instructions that, when executed by a wireless node (e.g., network entity), cause the wireless node to perform a method in accordance with any one of examples 12-22.
Example 27 is an apparatus for wireless communications, comprising: one or more memories, individually or in combination, having instructions; and one or more processors, individually or in combination, configured to execute the instructions and cause the apparatus to perform a method in accordance with any one of examples 1-11.
Example 28 is an apparatus for wireless communications, comprising: one or more memories, individually or in combination, having instructions; and one or more processors, individually or in combination, configured to execute the instructions and cause the apparatus to perform a method in accordance with any one of examples 12-22.
Example 29 is a wireless node (e.g., a UE), comprising: one or more transceivers; one or more memories, individually or in combination, having instructions; and one or more processors, individually or in combination, configured to execute the instructions and cause the wireless node to perform a method in accordance with any one of examples 1-11, wherein the one or more transceivers are configured to: receive the configuration of the plurality of subBWPs, the configuration of the plurality of PUCCH resource sets, and the indication that one of the subBWPs is an active subBWP, and transmit the PUCCH.
Example 30 is a wireless node (e.g., network entity), comprising: one or more transceivers; one or more memories, individually or in combination, having instructions; and one or more processors, individually or in combination, configured to execute the instructions and cause the wireless node to perform a method in accordance with any one of examples 12-22, wherein the one or more transceivers are configured to: transmit the configuration of the plurality of subBWPs, the configuration of the plurality of PUCCH resource sets, and the indication that one of the subBWPs is an active subBWP, and receive the PUCCH.

As used herein, a phrase referring to “at least one of” a list of items refers to any combination of those items, including single members. As an example, “at least one of: a, b, or c” is intended to cover: a, b, c, a-b, a-c, b-c, and a-b-c. Similarly, as used herein, a phrase referring to “one or more of” a list of items refers to any combination of those items, including single members. As an example, “one or more of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An apparatus for wireless communication, comprising:
one or more memories, individually or in combination, having instructions; and
one or more processors, individually or in combination, configured to execute the instructions and cause the apparatus to:
obtain a configuration of a plurality of sub-bandwidth parts (subBWPs) within a single bandwidth part, the subBWPs having different bandwidths;
obtain a configuration of a plurality of physical uplink control channel (PUCCH) resource sets, the configuration having an indication of whether each PUCCH resource set or each PUCCH resource in the plurality of PUCCH resource sets is valid for one or more of the subBWPs;
obtain an indication that one of the subBWPs is an active subBWP; and
output a PUCCH based on the active subBWP and based on whether the PUCCH resource set or the PUCCH resource is valid for the active subBWP.

2. The apparatus of claim 1, wherein the one or more processors, individually or in combination, are further configured to execute the instructions and cause the apparatus to output for transmission a capability associated with a maximum quantity of subBWPs, wherein the configuration of the plurality of PUCCH resource sets includes a quantity of PUCCH resource sets based on the capability.

3. The apparatus of claim 1, wherein the indication of whether each PUCCH resource set or each PUCCH resource in the plurality of PUCCH resource sets is valid for one or more of the subBWPs comprises a bitmap in which each bit of the bitmap indicates a valid status or an invalid status for each PUCCH resource set or each PUCCH resource for each subBWP.

4. The apparatus of claim 1, wherein the indication of whether each PUCCH resource set or the PUCCH resource in the plurality of PUCCH resource sets is valid for one or more of the subBWPs includes an indication of one or more valid subBWPs for each PUCCH resource.

5. The apparatus of claim 1, wherein the indication of whether each PUCCH resource set or each PUCCH resource in the plurality of PUCCH resource sets is valid for one or more of the subBWPs indicates that any PUCCH resource within a bandwidth of the subBWP is valid.

6. The apparatus of claim 1, wherein the one or more processors, individually or in combination, are further configured to obtain control information indicating a hybrid automatic repeat request (HARQ) resource as a codepoint that is mapped to the configured PUCCH resources and has a value that corresponds to a valid PUCCH resource for the active subBWP, wherein the PUCCH is output via the valid PUCCH resource for the active subBWP.

7. The apparatus of claim 1, wherein the one or more processors, individually or in combination, are further configured to obtain control information indicating a hybrid automatic repeat request (HARQ) resource as a codepoint that is mapped to only valid PUCCH resources for the active subBWP, wherein the PUCCH is output via one of the valid PUCCH resources for the active subBWP indicated by a value of the codepoint.

8. The apparatus of claim 1, wherein the one or more processors, individually or in combination, are further configured to execute the instructions and cause the apparatus to:
obtain control information from a wireless node, the control information indicating a transmission outside of a bandwidth of the active subBWP; and
output for transmission an indication that the active subBWP is out of synchronization with the wireless node.

9. The apparatus of claim 8, wherein a common resource of the plurality of PUCCH resource sets is valid for each of the subBWPs, wherein the indication that the active subBWP is out of synchronization with the wireless node is output for transmission via the common resource.

10. The apparatus of claim 8, wherein the one or more processors, individually or in combination, are further configured to execute the instructions and cause the apparatus to switch the active subBWP to a configured subBWP including the bandwidth for the output, wherein the output of the indication that the active subBWP is out of synchronization is on a PUCCH resource selected based on a switching time and a scheduled PUCCH resource.

11. An apparatus for wireless communication, comprising:
one or more memories, individually or in combination, having instructions; and
one or more processors, individually or in combination, configured to execute the instructions and cause the apparatus to:
output a configuration of a plurality of sub-bandwidth parts (subBWPs) within a single bandwidth part, the subBWPs having different bandwidths;
output a configuration of a plurality of physical uplink control channel (PUCCH) resource sets, the configuration having an indication of whether each PUCCH resource set or a PUCCH resource in the plurality of PUCCH resource sets is valid for one or more of the subBWPs;
output an indication that one of the subBWPs is an active subBWP; and
obtain a PUCCH based on the active subBWP and based on whether the PUCCH resource set or the PUCCH resource is valid for the active subBWP.

12. The apparatus of claim 11, wherein the one or more processors, individually or in combination, are further configured to execute the instructions and cause the apparatus to obtain a capability associated with a maximum quantity of subBWPs for a wireless node, wherein the configuration of the plurality of PUCCH resource sets includes a quantity of PUCCH resource sets based on the capability.

13. The apparatus of claim 11, wherein the indication of whether each PUCCH resource set or each PUCCH resource in the plurality of PUCCH resource sets is valid for one or more of the subBWPs comprises a bitmap in which each bit of the bitmap indicates a valid status or an invalid status for each PUCCH resource set or each PUCCH resource for each subBWP.

14. The apparatus of claim 11, wherein the indication of whether each PUCCH resource set or each PUCCH resource in the plurality of PUCCH resource sets is valid for one or more of the subBWPs includes an indication of one or more valid subBWPs for each PUCCH resource.

15. The apparatus of claim 11, wherein the indication of whether each PUCCH resource set or each PUCCH resource in the plurality of PUCCH resource sets is valid for one or more of the subBWPs indicates that any PUCCH resource within a bandwidth of the active subBWP is valid.

16. The apparatus of claim 11, wherein one or more processors, individually or in combination, are further configured to execute the instructions and cause the apparatus to output control information indicating a hybrid automatic repeat request (HARQ) resource as at least one of a codepoint that is mapped to one of the configured PUCCH resources and has a value that corresponds to a valid PUCCH resource for the active subBWP or a codepoint that is mapped to only valid PUCCH resources for the active subBWP.

17. The apparatus of claim 11, wherein one or more processors, individually or in combination, are further configured to execute the instructions and cause the apparatus to obtain an indication that a wireless node is out of synchronization with the active subBWP.

18. The apparatus of claim 17, wherein a common resource of the plurality of PUCCH resource sets is valid for each of the subBWPs, wherein the indication that the wireless node is out of synchronization with the active subBWP is obtained via the common resource.

19. The apparatus of claim 17, wherein one or more processors, individually or in combination, are further configured to execute the instructions and cause the apparatus to output a self-decodable retransmission in response to the indication that the wireless node is out of synchronization with the active subBWP.

20. The apparatus of claim 11, wherein the one or more processors, individually or in combination, are further configured to execute the instructions and cause the apparatus to monitor the PUCCH via a PUCCH resource based on the active subBWP and based on whether the PUCCH resource set or the PUCCH resource is valid for the active subBWP.
